(19) United States
(12) Patent Application Publication
(10) Pub. No.: US 2025/0300469 A1
(43) Pub. Date: Sep. 25, 2025

(54) Independent Multi-Channel Aircraft Battery Charger

(71) Applicant: Textron Aviation Inc., Wichita, KS (US)

(72) Inventors: Michael Louis Koonce, Wichita, KS (US); Steven Kurtzweil, Wichita, KS (US); August Bryce Ratzlaff, Wichita, KS (US); Vernon Weng-Yew Chang, Wichita, KS (US)

(21) Appl. No.: 18/613,971

(22) Filed: Mar. 22, 2024

(51) Int. Cl. H02J 7/00; B64F 5/60; H01M 10/44

(52) U.S. Cl. CPC H02J 7/0013; B64F 5/60; H01M 10/441; H02J 7/00032; H02J 7/0029; H02J 7/0042; H02J 7/0047; H02J 7/00712

(57) ABSTRACT

This disclosure provides methods, components, devices, and systems for simultaneously charging and maintaining several lithium-ion batteries suitable for aircraft using a multi-channel battery charger. Some aspects, more specifically, relate to a battery charger configured to charge multiple batteries at once and further configured to allow any of the batteries to be assigned a battery charging state allowing for optimization of a battery for usage, storage, or other situations. The charger is also configured to discharge batteries and prevent overcharging. Using a touchscreen or an external device, a user may conveniently assign a charging state to any battery plugged into the charger. In the event of battery degradation or an issue with the charger itself, software and hardware on board the charger may independently cease battery charging to prevent further damage.

### BACKGROUND

### 1. Field

Embodiments of the present invention relate generally to battery chargers, and more specifically to a single unit that allows for the charging of multiple batteries suitable for use in aircraft.

### 2. Related Art

Various means exist for charging aircraft batteries. In a hangar, a battery charger may be present, or more than one may be present to charge multiple batteries in the hangar. For example, U.S. Pat. No. 10,974,843 of Chang et al. discloses auxiliary power units for use in an aircraft that include one or more battery modules having bi-stable relays and a plurality of hot-swappable racks distributed throughout the aircraft for receiving the one or more battery modules.

Moreover, multi-battery chargers have been employed for lead acid batteries within aircraft. The multi-battery chargers can provide batteries and battery support units for aircraft. Additionally, these chargers can also test the performance of batteries. These tests include, but are not limited to, voltage tests, capacity tests, internal resistance tests, load tests, temperature tests, and balancing tests. For instance, temperature tests can monitor the temperature of the battery during charging and discharging. Excessive heat generation can be a sign of internal issues or inefficiencies in the battery.

### SUMMARY

In embodiments, a battery charger includes a power supply; a plurality of charging channels coupled to the power supply, wherein each channel of the plurality of charging channels is configured to supply a current to a battery plugged into a charging channel of the plurality of charging channels; a microcontroller communicatively coupled to the plurality of charging channels, wherein the microcontroller is configured to assign a state of charging to the charging channel; and a hardware architecture communicatively coupled to the microcontroller and the plurality of charging channels, wherein the hardware architecture is configured to disable charging on the charging channels.

In other embodiments, a system for monitoring a plurality of batteries comprises: a power supply; a microcontroller including software capable of monitoring batteries and assigning battery charge states; a plurality of battery charging channels coupled to the power supply, wherein the battery charging channels are configured to charge batteries plugged into the channels, collect diagnostic data of batteries plugged into the channels, and transmit the diagnostic data to the microcontroller; and a user interface communicatively coupled to the microcontroller and configured to display battery diagnostic data and further configured to accept input adjusting the charging state of the batteries plugged into the system.

In further embodiments, a method for battery lifespan management includes: collecting data from a battery plugged into a battery charging channel; assigning a battery charging state to the battery charging channel, wherein the battery charging state specifies a level of charge for the battery; determining battery charging parameters for the battery charging channel based on the assigned battery charging state and, at least in part, on the data; and applying the battery charging parameters to the battery charging channel.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the disclosure will be apparent from the following detailed description of the embodiments and the accompanying drawing figures.

### BRIEF DESCRIPTION OF THE DRAWING FIGURES

Embodiments of the disclosure are described in detail below with reference to the attached drawing figures, wherein:

FIG. 1 shows a perspective view of a multi-channel battery charger, in an embodiment;

FIG. 2 shows a component diagram detailing connections between hardware within the battery charger, in an embodiment;

FIG. 3 shows a process wherein software installed on board the battery charger charges, discharges, and/or monitors the condition of any connected batteries, in an embodiment; and

FIG. 4 illustrates a block diagram of an exemplary computing device, in accordance with embodiments of the present disclosure.

The drawing figures do not limit the disclosure to the specific embodiments disclosed and described herein. The drawings are not necessarily to scale, with emphasis instead being placed upon clearly illustrating the principles of the disclosure.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

Modern aircraft may require on-board batteries to power avionics, radio communications, and even fly-by-wire systems. Lithium-ion (Li-ion) batteries have proliferated across many industries including electric cars, mobile phones, and others, but lead-acid batteries remain more common within the aviation industry. Compared to lead acid batteries, Li-ion batteries allow for faster startup, increased reliability, and greater current supply during aircraft engine turnover. However, Li-ion batteries can also come with risks: overcharging of a Li-ion battery may lead to thermal runaway, while over-discharging of Li-ion batteries may damage the battery internally, subsequently leading to thermal runaway during recharge of the battery. Batteries plugged into a charger for an extended period may also experience issues with overcharging or battery degradation. Batteries can also degrade if they are not properly stored and charged to a specific charge level.

Within aircraft manufacturing and hangar storage, a charger that supplies current to multiple batteries is highly desirable. Problems relating to multi-channel chargers remain, however, as some chargers that supply a trickle charge may damage batteries that remain in storage connected to the charger, especially if the charger is unable to accommodate a specific battery chemistry, is not capable of providing a specified level of charge, or is unable to gather diagnostic data from the battery indicative of cell degradation. These chargers do not allow users to specify charging parameters for individual batteries connected to the charger. Diagnosing battery degradation has been limited for Li-ion batteries as chargers do not receive data from the battery directly but may read it through alternate means, such as by measuring the surface temperature of the battery. Thus, not only is an adaptable charger suitable for lithium-ion batteries desired, but a charger with a control scheme that allows users to specify charger settings and monitor individual batteries would efficiently suit the needs of aircraft manufacturing and maintenance without sacrificing optimal battery usage.

Various aspects of the disclosure provide methods, components, and systems that support a multi-charger battery system that may charge, discharge, and monitor a plurality of Li-ion batteries without leading to thermal runaway or long-term battery degradation. The charger possesses hardware that collects data communicated directly from the battery, such as internal battery temperature. The charger may assign one of three states to a connected battery to perform these tasks, such as a shipping state, a storage state, or a full charge state. In a shipping state, the battery is charged or discharged to be made suitable for shipping while free of a charger or electrical power interface. In a storage state, the battery enters a suspended state which minimizes cell degradation while the battery stays plugged in to the charger. In a full state, the battery is fully charged so that it is suitable for installation on board an aircraft. To configure a battery into any of these states, the charger may assign a corresponding static voltage or voltage mode to the battery and its charging terminal. Certain voltage modes may employ automatic voltage cycling for cell balancing and extending battery lifespans. Each state requires different voltages or voltage modes to configure the battery into the conditions specified by the charging state.

In some embodiments, the charger enables users to specify the desired charging settings for a battery and monitor any batteries plugged into the charger. In some implementations, a touchscreen display and internet or ethernet connectivity capability provide users with multiple options through which to interact with the charger. In some implementations, safety mechanisms integrated within the charger, including an alarm, notify users of battery issues as they appear to promote the extension of battery lifespan further and prevent wasting batteries. The charging functions of the charger may also be altered to accommodate a variety of Li-ion battery chemistries, such as when a user specifies a battery model plugged in to a charging channel or the battery charger automatically determines the model of battery plugged in. The battery may also prohibit the charging of unrecognized battery models as given by the battery serial number. As an additional safety feature, the charger hardware may shut down the battery operation independently of the software.

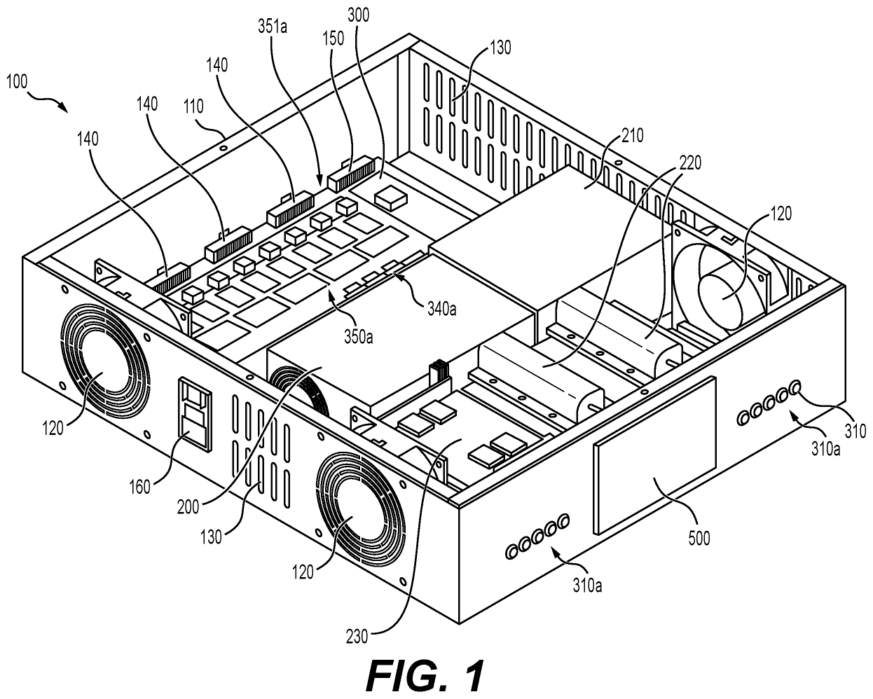

As depicted in FIG. 1, an embodiment multi-channel charger 100 comprises a case 110, fans 120, grilles 130, low-power charging terminals 140, and high-power charging terminals 150. Case 110 may comprise a metal chassis, frame, or other support structure that encases the hardware of multi-channel charger 100. Case 110 protects the internal components of multi-channel charger 100. Multi-channel charger 100 is depicted with the top of case 110 removed in FIG. 1 to display components within multi-channel charger 100, but in embodiments multi-channel charger 100 comprises minimal exposed circuitry.

In some embodiments, fans 120 and grilles 130 comprise the exterior of case 110. Fans 120 and grilles 130 provide cooling via promoting convection within case 110. In other embodiments, other means of cooling may be employed on multi-channel charger 100, such as water cooling or an alternate configuration of fans 120 and grilles 130 comprising more or fewer fans 120 or grilles 130.

To plug batteries into multi-channel charger 100 using charging cables, low-power charging terminals 140 and high-power charging terminals 150 are disposed on the surface of multi-channel charger 100. Either type of terminal may accommodate a particular size of an alternating current (AC) or a direct current (DC) plug, such as a 5.5 millimeter outer diameter charging plug or a 22-pin 3.00 mm-pitch Molex® Micro-Fit connector suitable for currents of up to 10.5 amps, wherein each connector is configured to plug in two batteries. Using a charging cable with one plug inserted into multi-channel charger 100, a battery may be electrically interfaced to multi-channel charger 100 via low-power charging terminals 140 or high-power charging terminals 150. Low-power charging terminals 140 may supply a low current, such as 1 amp, while high-power charging channels may supply a high current, such as 5 amps. To power the charger from a 120-volt wall outlet socket, or other available electric supply, power socket 160 accepts a power cord and is configured to electrically interface power supply 200 to a 120-volt wall outlet socket.

Power supply 200 is electrically interfaced to low-power charging terminals 140 and high-power charging terminals 150 such that power supply 200 may charge or discharge a battery plugged into one of the low-power charging terminals 140 or high-power charging terminals 150 along an electrical pathway. A shroud 210 is disposed over a portion of power supply 200 such that shroud 210 facilitates the direction of hot air out of case 110 and away from power supply 200. A load resistor 220 is electrically connected to each high-power charging terminal 150 to facilitate battery discharge on said channels. A heat sink 230 is disposed below load resistors 220 to facilitate the dissipation of heat from load resistors 220 in a similar fashion to shroud 210, and fans 120 may be disposed nearly adjacent to heat sink 230 or shroud 210 to facilitate cooling. Power supply 200 may supply current to low-power charging terminals 140 and

high-power charging terminals 150 via electrical pathways configured on a circuit board 300, wherein circuit board 300 comprises electrical pathways for battery charge and control/computer logic. Specifically, circuit board 300 comprises channel array 350a, charging circuit array 351a, and multiplexer array 340a. Each low-power charging terminal 140 and high-power charging terminal 150 is interfaced to a channel 350 of the channel array 350a, and each channel 350 comprises a charging circuit 351 from charging circuit array 351a and a multiplexer 340 from multiplexer array 340a. Logic circuits, charging circuits, and voltage regulators configured on circuit board 300 may enable the voltage supplied from power supply 200 to any of the low-power charging terminals 140 or high-power charging terminals 150 to be altered, allowing each channel 350 to supply a battery with a different current or voltage compared to other channels 350. A dedicated voltage regulator configured on each channel 350 may also be used in embodiments. Each channel 350 supplies power to a plugged-in battery independently of other channels 350.

A touchscreen display 500 is disposed on a face of case 110 such that a user may readily interact with touchscreen display 500. Options for battery charging and battery charging statuses may be displayed on touchscreen display 500, with users able to press on touchscreen display 500 to issue commands to multi-channel charger 100. A microcontroller integrated into or otherwise connected to touchscreen display 500 may communicate via electrical signals to power supply 200, circuit board 300, or any channel 350. Software installed in a non-volatile memory of the microcontroller may govern operations of charger 100, such as by dictating the level of voltage or current a battery is to be charged at. Together, low-power charging terminals 140 and high-power charging terminals 150 comprise a plurality of “charging channels” or “channels” (such as channel 350) into which batteries may be plugged in.

To monitor the status of each channel 350 of channel array 350a, a status LED 310 corresponding to a channel 350 is disposed on the surface of case 110 in an LED array 310a. A given status LED 310 may illuminate to convey a status of any battery plugged into a channel 350 or may convey the status of that channel 350. For instance, a status LED 310 may glow red in the event of a battery fault or a fault within channel 350 or may glow green to indicate a nominal status.

It is noted that FIG. 1 is intended to depict the major representative components of a multi-channel charger 100. In some embodiments, however, individual components may have greater or lesser complexity than as represented in FIG. 1, components other than or in addition to those shown in FIG. 1 may be present, and the number, type, and configuration of such components may vary.

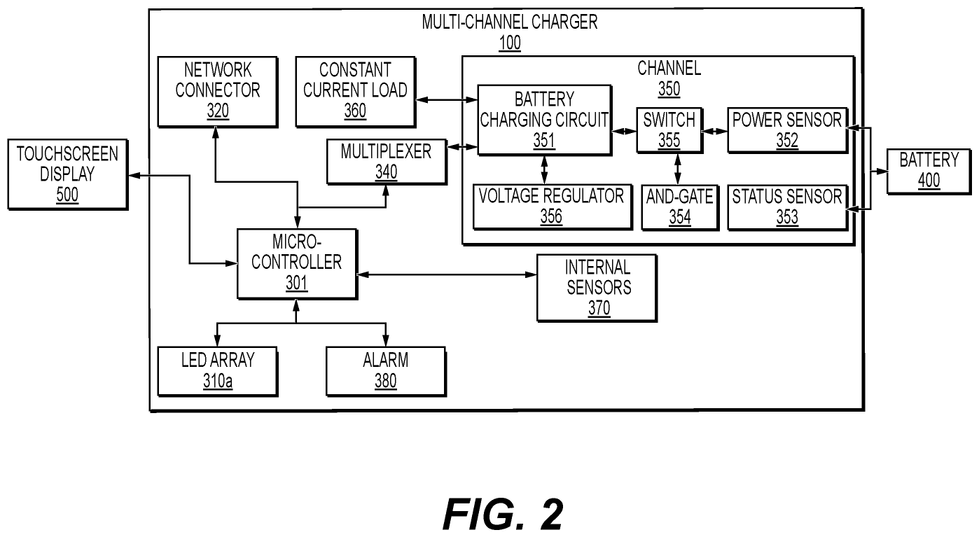

FIG. 2 depicts a high-level component diagram of hardware and hardware architecture included within circuit board 300, low-power charging terminals 140, and high-power charging terminals 150 of FIG. 1, in accordance with embodiments of the present disclosure. Multi-channel charger 100 comprises a battery charging and monitoring system with hardware and software configured to charge batteries 400 or cease battery charging in the event of an issue with battery 400 or multi-channel charger 100. Circuit board 300 comprises a microcontroller 301 configured to mediate signals between a network connector 320; a multiplexer 340; a battery 400 or batteries 400 each plugged in to a channel 350; channel 350 and its components; internal sensors 370; an alarm 380; and a touchscreen display 500. Signals sent by components to microcontroller 301 allow for the charging or discharging of batteries at desired settings, automatic cycling, and initiating warnings or terminating connections to any battery 400 in the event of component failure or battery degradation.

Microcontroller 301 comprises a computer with software installed in memory available on charger 100. Software installed within non-volatile memory of multi-channel charger 100, may issue and accept commands, instructions, or other inputs as received from a user or from the software itself. For instance, a command may be received from touchscreen display 500, and software may execute a particular set of instructions based off that command, such as to assign a “shipping” charging state to a channel 350. Commands may also be received from external devices communicating with network connector 320.

By executing instructions given by software, microcontroller 301 is configured to apply the current or voltage mandated by a setting to any battery 400 plugged into charger 100. Possible settings may include “shipping,” “storage,” or “full.” These settings may be assigned by a user but may be assigned automatically by microcontroller 301 in other embodiments. A shipping state sets a battery at a charge level appropriate for being shipped. A storage state sets a battery to a charge state suitable for keeping the battery in long-term storage. A full state brings a battery to or near full charge. In certain situations, additional settings may be defined by microcontroller 301 or by a user in communication with microcontroller 301.

To communicate with microcontroller 301, a user may interact with a touchscreen display 500 that is communicatively coupled to microcontroller 301. For instance, using an application on touchscreen display 500, a user may press a portion of touchscreen display 500 to indicate that a battery 400 plugged into a channel 350 on multi-channel charger 100 is to be set to a storage state. Microcontroller 301 may also send and receive communications with network connector 320. Network connector 320 may comprise an ethernet connection, a wi-fi router, or other component configured to communicate with an external device, such as a smartphone or personal computer. Using an external device communicating with network connector 320, a user may adjust the settings of components within multi-channel charger 100. While operating multi-channel charger 100, a user may specify a particular state for a battery 400 plugged into the charger, such as the aforementioned shipping, storage, or full states. A user may also monitor any battery 400 currently connected to multi-channel charger 100 via an external device in communication with network connector 320, or via touchscreen display 500. The external device may communicate with network connector 320 via internet or ethernet. A user may be able to see the current charge level of a battery 400 plugged into a certain channel 350. Further diagnostic information regarding a battery 400 or the status of hardware on multi-channel charger 100, such as hardware temperature detected by internal sensors 370, may be displayed to users interacting with multi-channel charger 100 through touchscreen display 500 or an external device.

Multiplexer 340 is electrically interfaced with microcontroller 301, is configured to act as a bridge between any channel 350, internal sensors 370, and microcontroller 301, and can allow a plurality of signals to reach microcontroller 301. Signals communicated from a channel 350 or internal sensors 370 pass through multiplexer 340 to microcontroller 301. A plurality of batteries 400 may be connected to multi-channel charger 100 via a plurality of channels 350. Each channel 350 comprises an individual terminal from low-power charging terminals 140 or high-power charging terminals 150 as seen in FIG. 1. Any number of channels 350 equal to two or greater may be present on multi-channel charger 100. Channels may be low power or high power to suit different charging needs. In an embodiment, eight channels 350 of multi-channel charger 100 are low-power charging terminals 140, while two channels 350 are high-power charging terminals 150, making for a total of 10 channels 350. For simplicity, a single battery 400 interfaced to a single channel 350 is inferred when not otherwise specified in the following description of channel 350 and its interactions with microcontroller 301.

Channel 350 comprises a battery charging circuit 351, a power sensor 352, a status sensor 353, an and-gate 354, a switch 355, and a voltage regulator 356 in embodiments. On high-powered channels, such as a channel 350 linked to a high-power charging terminal 150, said channel 350 is linked to a constant current load 360, which permits the discharge of a battery 400 on a high-powered channel. Each load resistor 220 may comprise constant current load 360 or otherwise carry out battery discharging on a high-powered charging terminal 150. A battery 400 is plugged into channel 350 via an electrical cable through one of low-power charging terminals 140 or high-power charging terminals 150. The electrical cable may transmit current and discrete signals between channel 350 and battery 400.

Battery charging circuit 351 comprises an adjustable constant current or constant voltage (CC/CV) battery charging circuit. Battery charging circuit 351 may be used to supply a constant current to battery 400, to maintain battery 400 at a constant voltage, or to vary the voltage supplied to battery 400 over time. The voltage or current supplied by battery charging circuit 351 is adjustable, and the voltage or current is set based on user input, the selected battery charging state, and, in embodiments, other data such as historical battery data regarding battery 400.

A voltage, current, or power is registered by power sensor 352, which lies along the electrical connection that interfaces battery charging circuit 351 and battery 400. Power sensor 352 may be a current sensor, a voltage sensor, or may comprise a plurality of sensors that register current, voltage, or other electrical data. As a component of channel 350, power sensor 352 transmits data to microcontroller 301 via multiplexer 340 to indicate the ongoing voltage or current being transmitted to a battery 400. Status sensor 353 may also communicate with microcontroller 301 via this pathway. Status sensor 353 receives serial data, temperature data, or other discrete signals directly from battery 400 which serves as diagnostic information regarding the status of battery 400. Hardware within battery 400 transmits this signal to status sensor 353 through the charging cable connecting channel 350 and battery 400. Thus, temperature data for battery 400 may comprise internal temperature of the battery rather than a surface temperature of the battery. Microcontroller 301 may interpret discrete signals from battery 400 as serial data, temperature data, or other diagnostics regarding battery 400.

Channel 350 also comprises and-gate 354, which is configured as a hardware failsafe mechanism that closes switch 355 when active. And-gate 354 receives two signals, including an enable signal from software installed on a component of multi-channel charger 100 and a “battery-OK” signal from battery 400. If either signal is dead, channel 350 will not engage because switch 355 will remain open, and battery 400 plugged into channel 350 will be unable to begin charging. For instance, if software designates that a battery is not to be charged, and-gate 354 will prevent the battery from charging. In another instance, if the battery does not provide a “battery-OK” signal, and-gate 354 will prevent the battery from charging Battery 400 may cease charging if an issue occurs during charging such that one of the conditions required by and-gate 354 is no longer met during charging. Other signals such as excess temperature warnings may be registered by and-gate 354 in other embodiments, and other hardware architectures may be configured to serve as hardware failsafe mechanisms.

Microcontroller 301 is further configured to perform automatic cycling of a battery 400 connected to channel 350. In an embodiment, each channel 350 comprises voltage regulator 356 configured with a digital to analog converter (DAC) that may adjust the voltage supplied to a battery 400 plugged into a channel 350. Signals, inputs, or commands from microcontroller 301 may adjust the settings on voltage regulator 356 to alter the voltage. Any state (i.e., “Shipping,” “Storage,” “Full,” or another state) may apply a non-static voltage mode to the battery under certain circumstances, such as if a battery reaches full charge (as specified by the “full” state), or if a battery is to be held in a suspended state (as specified by a “shipping” or “storage” state). Voltage regulation functions for a non-static voltage mode may be performed by software accessible to microcontroller 301. The automatic battery cycling may place the battery on a schedule wherein voltages and currents supplied to the battery are changed over time to optimize battery lifetime. For instance, for a first designated period of time, a battery 400 may be charged at a first voltage, while after this period of time, this voltage may be cycled to a second voltage. The voltage may also gradually be changed, such as with a linear reduction in voltage. This process may continue and may involve alternating between different voltages, supplying current in a manner that charges and discharges the battery, a combination thereof, or some other means of maintaining a specific set of conditions, such as a desired level of charge, within battery 400. The behavior of the automatic cycling may depend on the state that any battery is set to, with different states requiring different voltages that may be varied at different times during cycling.

Moreover, microcontroller 301 may track the history of charging and discharging of battery 400. Computer memory disposed within multi-channel charger 100 or available via an ethernet or wi-fi connection may store data for a particular battery 400. Using a serial number or other identifier from battery 400, data for battery 400 may be periodically stored in a data structure such as an array or matrix. For instance, a maximum battery charge level may be collected each time battery 400 is charged on multi-channel charger 100, and this charge data may be plotted, presented in a table, or otherwise made available to a user so that the user may monitor lifetime changes of battery 400. This monitoring may also be performed via an external device in communication with microcontroller 301 via network connector 320, allowing a user to access historical battery conditions of a battery 400 currently or previously connected to multi-channel charger 100 while away from multi-channel charger 100. Any historical battery data may also be used for a capacity check, wherein software available to microcontroller 301 computes the remaining battery capacity of battery 400.

Alarm 380 may be triggered by microcontroller in the event of a malfunction or issue with multi-channel charger 100 or a plugged-in battery 400. Alarm 380 may comprise an audible alarm such as a siren, a visual alarm such as a flashing light, or another warning executable by hardware interfaced to microcontroller 301. Internal sensors 370, which are configured to monitor ambient air temperature within multi-channel charger 100 but may directly monitor high-temperature charging components including power inductors or metal oxide semiconductor field-effect transistors (MOSFETs) within charging circuit 351, may send a signal to alarm 380 if an excessive or dangerous temperature is detected.

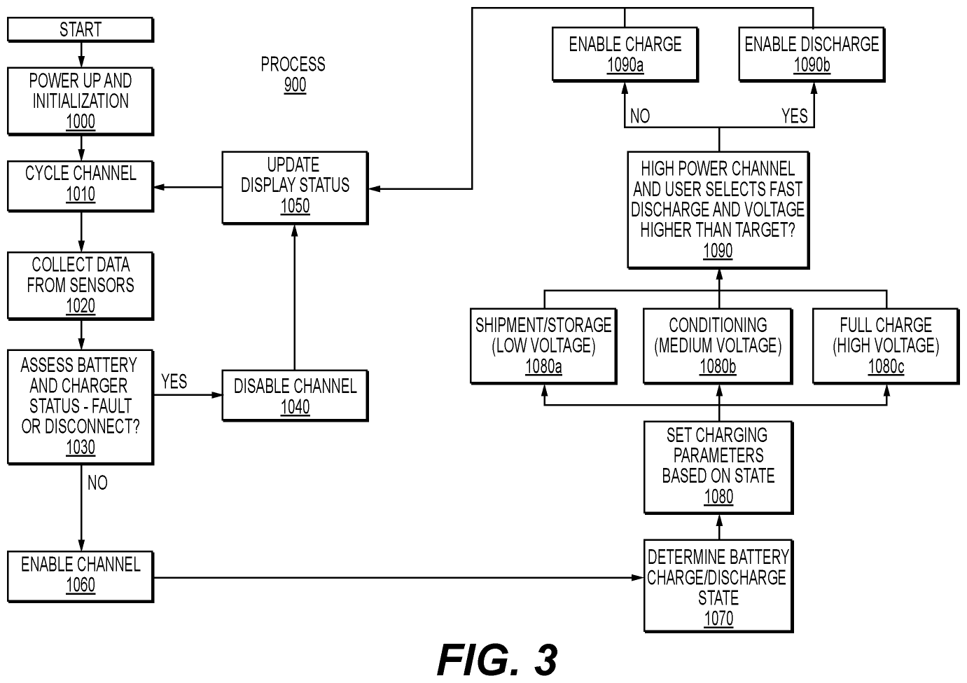

FIG. 3 depicts process 900, an embodiment operational routine or method for managing batteries plugged into multi-channel charger 100. Process 900 may be a process, method, or set of instructions performed by software installed in a memory of multi-channel charger 100. Microcontroller 301, as shown in FIG. 2, may comprise computer memory suitable for housing this software, and microcontroller 301 may execute functions of the software. Management of batteries may include charging batteries, discharging batteries, notifying a user of cell degradation within the battery, or adjusting the charging or discharging parameters assigned to batteries. Battery management enacted by process 900 may be configured to extend the lifespan of batteries plugged into multi-channel charger by reducing or preventing battery cell degradation during charging.

In step 1000, multi-channel charger 100 is powered on. Network connector 320 may communicatively couple with an external user device at this time, or during any other step in process 900. Software also enables multi-channel charger 100 to begin accepting user input at this time, such as from touchscreen display 500 or from an external device communicatively coupled to network connector 320. User input may be provided to multi-channel charger 100 at any step of process 900 independent of the current step being performed. Process 900 may rely on user input in certain steps.

In step 1010, a channel 350 is cycled to from a plurality of channels. Software installed on multi-channel charger 100 is configured to cycle to every channel 350 to monitor and charge each specific battery 400 plugged into each channel 350. It should be noted that each step of process 900 after step 1010 can be performed for each channel 350 individually. Channels may be cycled sequentially, in a user-defined order, or arbitrarily. Software installed in memory of multi-channel charger 100 may perform this cycling.

In step 1020, data is collected from channel 350 and multi-channel charger 100. Power sensor 352 and status sensor 353 read battery analog and discrete values from a battery 400 plugged into a channel 350. The analog and discrete data may include the voltage supplied to battery 400, the current supplied, the temperature of battery 400, a “battery-OK” signal from the battery hardware, or other signals that indicate the condition of battery 400. Internal analog data is read from internal sensors 370, including fan speed and charger temperature. Serial data is read from battery 400, such as a part ID or model number. Collected data may be stored in a memory such that microcontroller 301 may access the data for performing calculations of optimal battery charging parameters, or to allow a user to view collected data from a specific battery 400.

In step 1030, software assesses the state of battery 400 and multi-channel charger 100 using the data gathered in step 1020. These states differ from a user-assigned state (such as “Shipping,” “Storage,” or “Full”) in that they are assessments of the condition of battery 400 and charger 100. Possible states of battery 400 include but may not be limited to charging, discharging, disconnected, or at fault. For instance, a positive current registered by power sensor 352 may indicate that battery 400 is in the charging state. Likewise, a high temperature registered by status sensor 353 may be used to assign battery 400 a state of being at fault. The state of the multi-channel charger may include but is not limited to nominal or at fault. For instance, if internal sensors 370 register a high temperature, multi-channel charger 100 will be deemed to be in a state of being at fault. In case of any fault, alarm 380 may be triggered.

Step 1030 proceeds to step 1040 or 1060 depending on the states of battery 400 and charger 100. If a fault or disconnect is detected, the process moves to step 1040, wherein current monitored channel 350 is disabled, thereby prohibiting charge or discharge of battery 400. In embodiments, in the event of a failure within multi-channel charger 100, this may result in the disabling of all channels as process 900 iterates. Step 1040 proceeds to step 1050.

In step 1050, the display status of multi-channel charger 100 is updated. In the event of a fault or disconnect, a display such as the touchscreen display 500 may present a warning concerning the particular fault or disconnect detected, or any status LED 310 in LED array 310a may illuminate to indicate an error in a particular channel.

In the event of no fault or disconnect, step 1030 proceeds to step 1060, wherein a channel 350 is enabled if not already enabled. This allows battery charging operations to be performed or to continue on a specific channel 350.

In step 1070, software determines the particular state assigned to a battery 400 plugged into channel 350. A user may assign a state to a battery 400. A user may select a particular mode, such as shipping, storage, or full. In the event that no state is assigned, a state may automatically be assigned to battery 400, the charging channel may be disabled with the process continuing to step 1040, or the software may wait until user input is given before continuing to step 1080.

Each state requires a set of battery parameters necessary to meet the conditions of that state. For instance, if a battery 400 is assigned to “full,” channel 350 into which battery 400 is plugged in may be set to a high static voltage to charge the battery to full charge. A lower or higher voltage may be assigned depending on data collected from battery 400, or a voltage mode with automatic cycling may be assigned with the voltage set by a command, signal, or input sent to voltage regulator 356. Battery parameters other than voltage may be assigned to meet the conditions of a state, such as current. This depends on whether battery charging circuit 351 is configured as a constant current or constant voltage circuit. Additionally, given two batteries assigned the same state, one battery may be charged at a lower voltage to prevent cell degradation while another battery may be safely charged at a high voltage. This may be the result of automatic cycling, different battery chemistries, or different battery ages. Diagnostic information such as the serial number of each battery may be used to determine the model and age of battery being charged, and a set of optimal battery charging parameters may then be applied to that battery. Thus, multi-channel charger 100 is configured to extend battery lifespans. In other embodiments, multi-channel charger 100 may charge only a single model of Li-ion batteries.

Automatic battery cycling performed by multi-channel charger 100 may be executed by software installed on multi-channel charger 100. Combined with other features, including user input, a plurality of modes to which a battery can be set, and the presence of multiple channels through which a battery may be charged, multi-channel charger 100 is thus able to monitor and maintain multiple batteries over an extended period of time. In embodiments, battery 400 may remain plugged into multi-channel charger 100 indefinitely if assigned a “Storage” state.

In step 1080, charging parameters are applied to battery 400 based on the assigned charging state. With battery 400 plugged into channel 350, battery charging circuit 351 may be adjusted to apply charging parameters to battery 400. An example charging parameter includes voltage, wherein the voltage on channel 350 is set based on the state assigned to a battery. Pathway 1080a sets a low voltage for the purposes of shipment or storage. Pathway 1080b sets a moderate voltage for conditioning the battery and maintaining it in storage on the charger. Specific charging voltages assigned may depend on the specific types of batteries 400 used. In an embodiment, a low voltage constitutes a voltage less than or equal to 28 V, while a high voltage constitutes a voltage greater than 28 V. Pathway 1080c sets the battery to be fully charged so that the battery may be installed on an aircraft, and thus uses a high (possibly maximum) voltage to charge the battery expediently. In other embodiments, more or fewer charging states and associated voltages, voltage modes, and automatic cycling routines may be employed by multi-channel charger 100, and other charging parameters, such as a current, resistance, or power may be applied to battery 400 with an otherwise constant voltage.

A channel 350 that supplies high power (such as a channel 350 comprising a high-power charging terminal 150, as shown in FIG. 1) may perform a “fast discharge” of a battery. In this case, a battery may be discharged with a voltage exceeding a target voltage. In step 1130, process 900 checks that three conditions are met before proceeding with a fast discharge. If a battery is on a high-power channel, a user has selected battery discharge, and the voltage is higher than a target voltage, the 3 conditions are met, and the process continues to step 1090b, where discharge of the battery is enabled. If not all of these conditions are met, the process continues to step 1090a, where the battery is charged. Batteries not plugged into high-power channels always proceed to step 1090a instead of step 1090b.

Both steps 1090a and 1090b proceed to step 1060, where the display is updated. If a battery moves from one state to another, such as from disconnected to connected, the display status may reflect this. On a touchscreen display 500, this may appear as a message indicating that a battery is now connected, or a status LED 310 may light up or change color. A change in the current charging state of the battery connected to the current channel being monitored in the cycle may also be displayed.

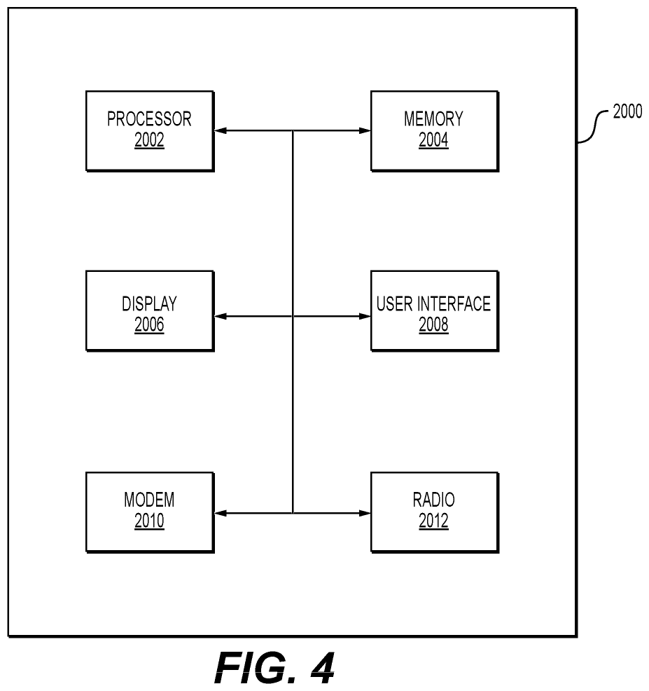

Having described an overview of embodiments of the present technology, an example operating environment in which embodiments of the present technology may be implemented is described in order to provide a general context for various aspects of the present technology. Referring now to FIG. 4, an exemplary operating environment for implementing embodiments of the present technology is shown and designated generally as computing device 2000. Computing device 2000 is but one example of a suitable computing environment and is not intended to suggest any limitation as to the scope of use or functionality of the technology. Neither should computing device 2000 be interpreted as having any dependency or requirement relating to any one or combination of components illustrated.

The technology of the present disclosure may be described in the general context of computer code or machine-useable instructions, including computer-executable instructions such as program modules, being executed by a computer or other machines, such as a personal data assistant or other handheld devices. Generally, program modules, including routines, programs, objects, components, data structures, etc., refer to code that performs particular tasks or implement particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

FIG. 4 shows a block diagram of an example computing device 2000 that facilitates a state of charging to battery charging channels of a battery charger, substantially similar to the microcontroller 301 described with reference to FIG. 2. In some examples, the computing device 2000 is configured to perform the process 900 described with reference to FIG. 3. The computing device 2000 may include one or more chips, systems on a chip (SoCs), chipsets, packages, components or devices that individually or collectively constitute or comprise a processing system. The processing system may interface with other components of the computing device 2000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the computing device 2000 may transmit the information output from the chip. In such an example, the second interface may refer to an interface between the processing system of the chip and a reception component, such that the computing device 2000 may receive information that is then passed to the processing system. In some such examples, the first interface may obtain information, such as from the transmission component, and the second interface may also output information, such as to the reception component.

The processing system of the computing device 2000 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASICs), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with multiple radios (collectively “the radio”), multiple radio frequency (RF) chains or multiple transceivers, each of which may in turn be coupled with one or more of multiple antennas. In some implementations, one or more processors of the processing system include or implement one or more of the radios, RF chains or transceivers.

In some examples, the computing device 2000 can be configurable or configured for use in a multi-channel battery charger, such as the multi-channel battery charger 100 described with reference to FIG. 1. In some other examples, the computing device 2000 can be a microcontroller that includes such a processing system and other components such as microcontroller 301 with reference to FIG. 2.

The computing device 2000 is capable of transmitting and receiving wireless communications in the form of, for example, wireless packets or data elements. For example, the computing device 2000 can be configurable or configured to transmit and receive packets in the form of physical layer PPDUs and MPDUs conforming to one or more of the IEEE 802.11 family of wireless communication protocol standards. In some other examples, the computing device 2000 can be configurable or configured to transmit and receive signals and communications conforming to one or more 3GPP specifications including those for 4G NR or 6G.

In some examples, the computing device 2000 also includes or can be coupled with one or more application processors which may be further coupled with one or more other memories. In some examples, the computing device 2000 further includes at least one external network interface coupled with the processing system that enables communication with a core network or backhaul network that enables the computing device 2000 to gain access to external networks including the Internet.

The computing device 2000 may include a processor component 402, a memory component 404, a display component 2006, a user interface component 2008, a modem component 2010, and a radio component 2012. Portions of one or more of the components 406, 408, and 412 may be implemented at least in part in hardware or firmware. In some examples, at least some of the components 406, 408, and 412 of computing device 2000 are implemented at least in part by a processor and as software stored in a memory. For example, portions of one or more of display component 2006, and the user interface component 2008 can be implemented as non-transitory instructions (or “code”) executable by processor 2002 to perform the functions or operations of the respective module.

In some implementations, processor 2002 may be a component of a processing system. A processing system may generally refer to a system or series of machines or components that receives inputs and processes the inputs to produce a set of outputs (which may be passed to other systems or components of, for example, computing device 2000). For example, a processing system of computing device 2000 may refer to a system including the various other components or subcomponents of computing device 2000, such as the processor, or a transceiver, or a communications manager, or other components or combinations of components of computing device 2000. The processing system of computing device 2000 may interface with other components of computing device 2000 and may process information received from other components (such as inputs or signals) or output information to other components. For example, a chip of computing device 2000 may include a processing system, a first interface to output information and a second interface to obtain information. In some implementations, the first interface may refer to an interface between the processing system of the chip and a transmitter, such that computing device 2000 may transmit information output from the chip. In some implementations, the second interface may refer to an interface between the processing system of the chip and a receiver, such that computing device 2000 may obtain information or signal inputs, and the information may be passed to the processing system. A person having ordinary skill in the art will readily recognize that the first interface also may obtain information or signal inputs, and the second interface also may output information or signal outputs.

Processor 2002 is capable of, configured to, or operable to processes information received through radio component 2012, and processes information to be output through radio component 2012 for transmission through the wireless medium. Processor 2002 may perform logical and arithmetic operations using program instructions stored within memory 2004. The instructions in memory 2004 may be executable (by processor 2002, for example) to implement the methods described herein.

Memory 2004 is capable of, configured to, or operable to store and communicate instructions and data to and from processor 2002.

User interface component 2008 may be any device that allows a user to interact with computing device 2000, such as a microphone, dials, buttons, et cetera. In aspects, user interface component 2008 may be integrated with display component 2006 to present a touchscreen such as touchscreen display 500 with reference to FIG. 2.

Modem component 2010 may be any device configured to transmit data from computing device 2000 to another device on a common network such as via the Internet, a local area network, a wide area network, or another suitable network. In embodiments, computing device 2000 may not comprise modem component 2010 and may be interfaced via wired or wireless connection to an external modem for transmission of data on a network.

Radio component 2012 includes at least one radio frequency transmitter and at least one radio frequency receiver, which may be combined into one or more transceivers. The transmitter(s) and receiver(s) may be coupled to one or more antennas. In some aspects, processor 2002, memory 2004, and radio component 2012 may collectively facilitate the wireless communication of computing device 2000 with other wireless communication devices over multiple frequency bands (such as 2.4 GHz, 5 GHZ, or 6 GHz).

The present invention may be a system, a method, and/or a computer program product at any possible technical detail level of integration. The computer program product may include a computer-readable storage medium (or media) having computer readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (R.O.M.), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (I.S.A.) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (P.L.A.) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations and are contemplated within the scope of the claims.

What is claimed is:

1. A battery charger comprising:
a power supply;
a plurality of charging channels coupled to the power supply, wherein each channel of the plurality of charging channels is configured to supply a current to a battery plugged into a charging channel of the plurality of charging channels;
a microcontroller communicatively coupled to the plurality of charging channels, wherein the microcontroller is configured to assign a state of charging to the charging channel; and
a hardware architecture communicatively coupled to the microcontroller and the plurality of charging channels, wherein the hardware architecture is configured to disable charging on any of the charging channels.

2. The battery charger of claim 1, further including a touchscreen display communicatively coupled to the microcontroller, wherein the touchscreen display is configured to display a status of each charging channel.

3. The battery charger of claim 1, further including a network connector configured to receive commands from an external device, wherein the commands specify a state of charging for a charging channel.

4. The battery charger of claim 1, wherein each channel comprises a switch coupled to an and-gate configured to close a switch, thereby allowing the battery to charge.

5. The battery charger of claim 1, further including a plurality of cooling units disposed along an exterior surface of the battery charger.

6. The battery charger of claim 1, wherein each channel includes a plurality of sensors configured to collect charging and diagnostic information associated with the battery.

7. The battery charger of claim 6, wherein the microcontroller uses the charging and diagnostic information collected by the plurality of sensors on a channel to determine if a battery plugged into the channel is at fault.

8. A system for monitoring a plurality of batteries comprising:
a power supply;
a microcontroller including software capable of monitoring batteries and assigning battery charge states;
a plurality of battery charging channels coupled to the power supply, wherein the battery charging channels are configured to charge batteries plugged into the channels, collect diagnostic data of batteries plugged into the channels, and transmit the diagnostic data to the microcontroller; and
a user interface communicatively coupled to the microcontroller and configured to display battery diagnostic data and further configured to accept input adjusting the charging state of the batteries plugged into the system.

9. The system of claim 8, wherein each channel of the plurality of battery charging channels is configured to supply a low current or a high current.

10. The system of claim 8, wherein the software includes instructions that allow communications between an external device and the microcontroller, wherein the communications include commands to assign the charging state of a channel of the plurality of battery charging channels.

11. The system of claim 8, wherein the software includes instructions that allow a voltage supplied to a battery plugged into a battery charging channel of the plurality of battery charging channels to be cycled.

12. The system of claim 8, further comprising internal temperature sensors connected to the microcontroller and configured to monitor the temperature of the power supply.

13. The system of claim 8, wherein the software includes instructions that cease battery charging on a channel of the plurality of battery charging channels when a fault is detected.

14. A method for battery lifespan management, comprising:
collecting data from a battery plugged into a battery charging channel;
assigning a battery charging state to the battery charging channel, wherein the battery charging state specifies a level of charge for the battery;
determining battery charging parameters for the battery charging channel based on the battery charging state and, at least in part, on the data; and
applying the battery charging parameters to the battery charging channel.

15. The method of claim 14, wherein the data from the battery is stored as historical battery data.

16. The method of claim 15, wherein the battery charging parameters are determined also from the historical battery data.

17. The method of claim 14, wherein assigning the battery charging state includes:
displaying battery charging state configurations on a touchscreen display;
receiving an input indicating a selection of a selected battery charging state from the battery charging state configurations displayed on the touchscreen display; and
applying the selected battery charging state as the battery charging state of the battery charging channel.

18. The method of claim 14, further including:
detecting, via a battery charger, a second battery plugged into a second battery charging channel;
collecting additional data from the second battery plugged into the second battery charging channel; and
assigning the battery charging state to the second battery charging channel based, at least in part, on the additional data.

19. The method of claim 18, further including:
detecting, via the battery charger, a fault associated with the battery charging channel; and
disabling the battery charging channel based on the fault.

20. The method of claim 14, wherein the data includes a battery temperature, a battery serial number, and a battery power level.
